(19) United States
(12) Patent Application Publication
(10) Pub. No.: US 2024/0378305 A1
(43) Pub. Date: Nov. 14, 2024

(54) OBJECT REFERENCE WITH SELECTABLE SCOPE

(71) Applicant: Snowflake Inc., Bozeman, MT (US)

(72) Inventors: Suraj P. Acharya, Newark, CA (US); Jennifer Wenjun Bi, Palo Alto, CA (US); Khalid Zaman Bijon, Santa Cruz, CA (US); Damien Carru, New York, NY (US); Lin Chan, Bellevue, WA (US); Tianyi Chen, Kirkland, WA (US); Jeremy Yujui Chen, Newark, CA (US); Thierry Cruanes, San Mateo, CA (US); Benoit Dageville, San Mateo, CA (US); Simon Holm Jensen, Menlo Park, CA (US); Boxin Jiang, Sunnyvale, CA (US); Dmitry A. Lychagin, San Jose, CA (US); Subramanian Muralidhar, Mercer Island, WA (US); Shuaishuai Nie, Redmond, WA (US); Eric Robinson, Sammamish, WA (US); Sahaj Saini, Seattle, WA (US); David Schultz, Piedmont, CA (US); Kevin Wang, San Mateo, CA (US); Wenqi Wei, Bozeman, MT (US); Zixi Zhang, San Mateo, CA (US); Xingzhe Zhou, Redmond, WA (US)

(21) Appl. No.: 18/316,787

(22) Filed: May 12, 2023

(51) Int. Cl. G06F 21/62; G06F 21/60

(52) U.S. Cl. CPC G06F 21/6218; G06F 21/604; G06F 2221/2113

(57) ABSTRACT

Systems and methods for generating object references with selectable scopes are provided. The systems and methods perform operations including calling, by a first entity, a reference generator function using one or more arguments associated with a database object that the first entity is authorized to access according to a first set of access privileges, the one or more arguments comprising a scope definition that defines persistence of a reference. The operations include obtaining, from the reference generator function, a reference to the database object, the reference persisting according to the scope definition. The operations include passing the reference to a second entity to enable the second entity to perform one or more database operations on the database object according to a second set of access privileges derived from the first set of access privileges.

### TECHNICAL FIELD

Examples of the disclosure relate generally to data platforms and databases and, more specifically, to managing access privileges for database objects.

### BACKGROUND

Databases are widely used for data storage and access in computing applications. A goal of database storage is to provide enormous sums of information in an organized manner so that it can be accessed, managed, updated, and shared. In a database, data may be organized into rows, columns, and tables. Databases are used by various entities and companies for storing information that may need to be accessed or analyzed. Various operations performed on a database, such as joins and unions, involve combining query results obtained from different data sources (e.g., different tables, possibly on different databases) into a single query result. The various operations that can be performed on the databases are controlled based on access privileges of requesting entities.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a network-based data platform, in accordance with some examples.

FIG. 2 is a block diagram illustrating components of a compute service manager, in accordance with some examples.

FIG. 3 is a block diagram illustrating components of an execution platform, in accordance with some examples.

FIG. 4 is a block diagram of an access privileges system, in accordance with some examples.

FIG. 5 is an illustrative operation of the access privileges system, in accordance with some examples.

FIG. 6 is an illustrative access privileges table of the access privileges system, in accordance with some examples.

FIG. 7 is a flow diagram illustrating operations of the access privileges system, in accordance with some examples.

FIG. 8 illustrates a diagrammatic representation of a machine in the form of a computer system within which a set of instructions may be executed for causing the machine to perform any one or more of the methodologies discussed herein, in accordance with some examples.

### DETAILED DESCRIPTION

Reference will now be made in detail to specific examples for carrying out the inventive subject matter. These examples are illustrated in the accompanying drawings, and specific details are set forth in the following description in order to provide a thorough understanding of the subject matter. It will be understood that these examples are not intended to limit the scope of the claims to the illustrated examples. On the contrary, they are intended to cover such alternatives, modifications, and equivalents as may be included within the scope of the disclosure.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. With respect to type of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems.

In a typical implementation, a data platform includes one or more databases that are maintained on behalf of a customer account. The data platform may include one or more databases that are respectively maintained in association with any number of customer accounts, as well as one or more databases associated with a system account (e.g., an administrative account) of the data platform, one or more other databases used for administrative purposes, and/or one or more other databases that are maintained in association with one or more other organizations and/or for any other purposes. A data platform may also store metadata in association with the data platform in general and in association with, as examples, particular databases and/or particular customer accounts as well. The database can include one or more objects, such as tables, functions, and so forth.

Users and/or executing processes that are associated with a given customer account may, via one or more types of clients, be able to cause data to be ingested into the database, and may also be able to manipulate the data, add additional data, remove data, run queries against the data, generate views of the data, and so forth.

In an example implementation of a data platform, a given database is represented as an account-level object within a customer account, and the customer account may also include one or more other account-level objects such as entities, users, roles, instances, bundles, native applications, and/or the like. These are all generally referred to individually or collectively as an entity or process of an entity. Furthermore, a given account-level database object may itself contain one or more objects such as tables, schemas, views, streams, tasks, and/or the like.

A given table may be organized as records (e.g., rows or a collection of rows) that each include one or more attributes (e.g., columns). A data platform may physically store database data in multiple storage units, which may be referred to as blocks, micro-partitions, and/or by one or more other names. In an example, a column of a database can be stored in a block and multiple blocks can be grouped into a single file. That is, a database can be organized into a set of files where each file includes a set of blocks. Consistent with this example, for a given column, all blocks are stored contiguously and blocks for different columns are row aligned. Data stored in each block can be compressed to reduce its size. A block storing compressed data may also be referred to as a “compression block” herein. As referred to herein, a “record” is defined as a collection of data (e.g., textual data) in a file that is organized by one or more fields, where each field can include one or more respective data portions (e.g., textual data, such as strings). Each field in the record can correspond to a row or column of data in a table that represents the records in the file. It should be understood that the terms “row” and “column” are used for illustration purposes and these terms are interchangeable. Data arranged in a column of a table can similarly be arranged in a row of the table.

In certain systems, a set of objects of a database are usually owned by a particular entity or process (e.g., a first entity) in which the entity or process has full access privileges for the set of objects. For example, the first entity can modify or delete portions of the set of objects. The first entity can share access to the set of objects with a second entity or process to allow the second entity or process to perform a certain set of functions with respect to the set of objects. One way in which the set of objects can be shared is by actually sending those objects to the second entity. However, sharing of the objects in this way can consume a great deal of extra storage resources and processing resources and can also violate certain security and privacy measures. Another way to share access to the set of objects is by manually specifying an identity of the second entity to which access needs to be shared and indicating the level of access privilege to provide to the second entity. While such approaches generally work, there is a need to revoke access from the second entity after the operations being performed by the second entity are completed. This is to ensure that data privacy and security remains intact. Also, having to manually specify the objects being shared across a wide range of objects can be tedious and consume a great deal of time. Tracking the sharing of such shared objects can also be difficult which can result in some objects being shared beyond a desired scope of access or period of access.

Namely, the process to remove the privileges (permissions) is usually manual, tedious, and time consuming. Also, remembering to revoke such permissions carries a large processing burden which consumes a great deal of resources. In addition, the process of manually managing privileges (permissions) for database objects is time consuming, inefficient, and prone to human error, which can result in waste of time, network, and processing device resources.

Aspects of the present disclosure include systems, methods, and devices to address, among other problems, the aforementioned shortcomings of conventional data platforms by intelligently sharing access privileges (permissions) for various database objects and automatically managing such privileges (permissions) in a computationally efficient manner and in a way that maintains data privacy and security. Specifically, a unique textual or string reference (e.g., a reference that does not contain a link) is created by the first entity. The reference is associated with a particular database object for which the first entity has access privileges. As part of creating the reference, a specialized reference generator function is called, which receives a scope definition as one or more arguments. The scope definition can define persistence of the reference as temporary, permanent, session based, instance based, root query based, and so forth. The unique textual or string reference is generated according to the scope definition and can then be provided to a second entity to share at least a subset of the access privileges of the first entity with the second entity. The second entity can perform one or more database operations on the database object by assuming the security protocol and identity of the first entity and calling a function, such as via an application programming interface (API), using the unique textual reference as a field or argument of the function.

In such ways, because the unique textual reference is a random sequence of characters (e.g., a string) and is associated with a scope definition, access to the database object can be controlled efficiently. Also, because the unique textual reference does not include a link, the storage location and security associated with the database object remains hidden from the second entity, which preserves the secure nature of the database object while allowing the second entity to access and operate on the database object.

In some examples, the disclosed techniques perform operations including calling, by a first entity, a reference generator function using one or more arguments associated with a database object that the first entity is authorized to access according to a first set of access privileges, the one or more arguments comprising a scope definition that defines persistence of a reference. The operations include obtaining, from the reference generator function, a reference to the database object, the reference persisting according to the scope definition. The operations include passing the reference to a second entity to enable the second entity to perform one or more database operations on the database object according to a second set of access privileges derived from the first set of access privileges.

In some examples, the disclosed techniques allow the first entity to call a function to obtain a history of access associated with the database object. The history of access can provide to the first entity a list of database operations that have been performed by one or more other entities on the database object using the reference associated with the database object. This provides the first entity greater control over how the reference is used. The first entity can also call a function to retrieve a full list of references associated with one or more database objects and their corresponding scope definitions and/or access patterns. Using this information, the first entity can selectively remove or delete certain references that may have become stale.

By performing operations for sharing access privileges and managing such access privileges in this manner, the data platform increases utilization of execution node processing capability and avoids waste of resources and inefficient use of resources. Specifically, rather than having a human manually create and manage access permissions or privileges, which wastes a great deal of time and effort, the disclosed system can automate this process to improve the overall efficiency of the system, which improves the overall functioning of the device.

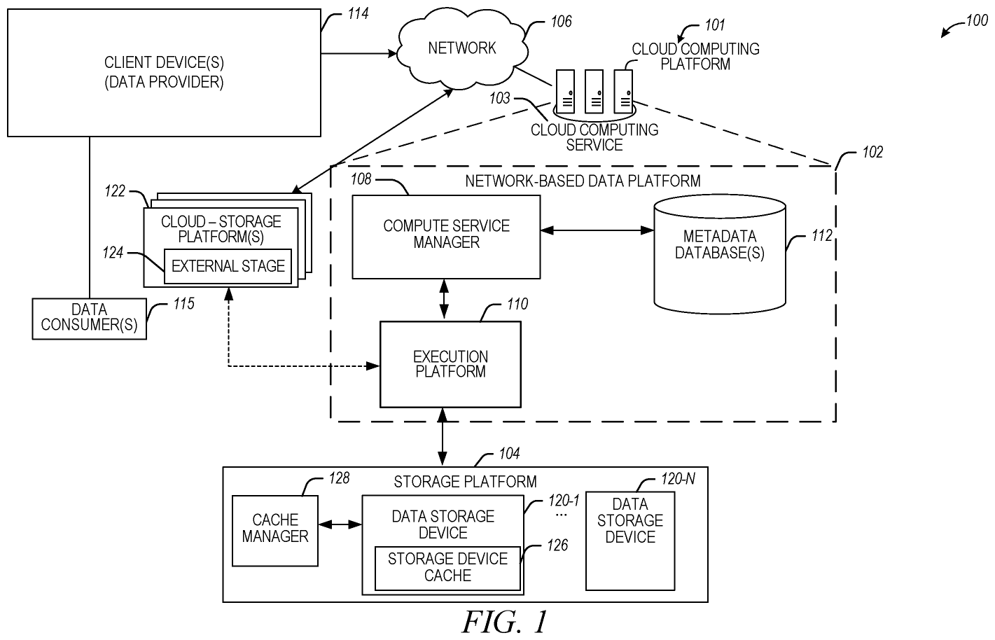

FIG. 1 illustrates an example computing environment 100 that includes a data platform in the example form of a network-based data platform 102, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other embodiments, the computing environment may comprise another type of network-based database system or a cloud data platform. For example, in some aspects, the computing environment 100 may include a cloud computing platform 101 with the network-based data platform 102 and a storage platform 104 (also referred to as a cloud storage platform). The cloud computing platform 101 provides computing resources and storage resources that may be acquired (purchased) or leased and configured to execute applications and store data.

The cloud computing platform 101 may host a cloud computing service 103 that facilitates storage of data on the cloud computing platform 101 (e.g., data management and access) and analysis functions (e.g., structured query language (SQL) queries, analysis), as well as other processing capabilities (e.g., parallel execution of sub-plans, as described herein). The cloud computing platform 101 may include a three-tier architecture: data storage (e.g., storage platforms 104 and 122), an execution platform 110 (e.g., providing query processing), and a compute service manager 108 providing cloud services.

It is often the case that organizations that are customers of a given data platform also maintain data storage (e.g., a data lake) that is external to the data platform (e.g., one or more external storage locations). For example, a company could be a customer of a particular data platform and also separately maintain storage of any number of files—be they unstructured files, semi-structured files, structured files, and/or files of one or more other types—on, as examples, one or more of their servers and/or on one or more cloud-storage platforms such as AMAZON WEB SERVICES™ (AWS™), MICROSOFT® AZURE®, GOOGLE CLOUD PLATFORM™, and/or the like. The customer's servers and cloud-storage platforms are both examples of what a given customer could use as what is referred to herein as an external storage location. The cloud computing platform 101 could also use a cloud-storage platform as what is referred to herein as an internal storage location concerning the data platform. The techniques described in this disclosure pertain to non-volatile storage devices that are used for the internal storage location and/or the external storage location.

From the perspective of the network-based data platform 102 of the cloud computing platform 101, one or more files that are stored at one or more storage locations are referred to herein as being organized into one or more of what is referred to herein as either “internal stages” or “external stages.” Internal stages are stages that correspond to data storage at one or more internal storage locations, and external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location. For example, in some data-platform implementations, it is a customer's choice whether to create one or more external stages (e.g., one or more external-stage objects) in the customer's data-platform account as an organizational and functional construct for conveniently interacting via the data platform with one or more external files.

As shown, the network-based data platform 102 of the cloud computing platform 101 is in communication with the cloud storage platforms 104 and 122 (e.g., Amazon Web Services (AWS)®, Microsoft Azure Blob Storage®, or Google Cloud Storage). The network-based data platform 102 is a network-based system used for reporting and analysis of integrated data from one or more disparate sources including one or more storage locations within the cloud storage platform 104. The cloud storage platform 104 comprises a plurality of computing machines and provides on-demand computer system resources such as data storage and computing power to the network-based data platform 102.

The network-based data platform 102 comprises a compute service manager 108, an execution platform 110, and one or more metadata databases 112. The network-based data platform 102 hosts and provides data reporting and analysis services to multiple client accounts.

The compute service manager 108 coordinates and manages operations of the network-based data platform 102. The compute service manager 108 also performs query optimization and compilation as well as managing clusters of computing services that provide compute resources (also referred to as “virtual warehouses”). The compute service manager 108 can support any number of client accounts such as end-users providing data storage and retrieval requests, system administrators managing the systems and methods described herein, and other components/devices that interact with compute service manager 108.

The compute service manager 108 is also in communication with a client device 114. The client device 114 corresponds to a user of one of the multiple client accounts supported by the network-based data platform 102. A user may utilize the client device 114 to submit data storage, retrieval, and analysis requests to the compute service manager 108. Client device 114 (also referred to as user device 114) may include one or more of a laptop computer, a desktop computer, a mobile phone (e.g., a smartphone), a tablet computer, a cloud-hosted computer, cloud-hosted serverless processes, or other computing processes or devices that may be used to access services provided by the cloud computing platform 101 (e.g., cloud computing service 103) by way of a network 106, such as the Internet or a private network.

In the description below, actions are ascribed to users, particularly consumers and providers or entities. Such actions shall be understood to be performed concerning client device (or devices) 114 operated by such users. For example, notification to a user may be understood to be a notification transmitted to client device 114, input or instruction from a user may be understood to be received by way of the client device 114, and interaction with an interface by a user shall be understood to be interaction with the interface on the client device 114 by a data consumer 115. In addition, database operations (joining, aggregating, analysis, etc.) ascribed to a user (consumer or provider) shall be understood to include performing such actions by the cloud computing service 103 in response to an instruction from that user.

In some cases, the actions are performed through native applications. Specifically, the cloud computing platform 101 enables users of a data marketplace to build native applications that can be shared with other users of the data marketplace. The native applications can be published and discovered in the data marketplace like any other data listing, and consumers can install them in their account to serve their needs (e.g., data processing needs). This helps to bring data processing services and capabilities to consumers instead of requiring a consumer to share data to, e.g., a service provider who can perform these data processing services and share the processed data back to the consumer. Stated differently, instead of an entity having to share data with a third party, having the third party run their service on it, and sending results back to the entity, the application functionality may be encapsulated, and then shared with the entity so that the entity does not have to share their potentially sensitive data. The cloud computing platform 101 can allow users to embed references in the native applications. This way, when a third-party user runs the native application, the native application can instantiate and call references to database objects that may or may not be owned by the third-party user. The native application can access the database objects using the rights and privileges specified by the reference to the database objects. This preserves data security and integrity of the overall system.

As with sharing of data, sharing of a native application (hereinafter referred to as an application) may be performed using a shared container. A provider may define an application share object (same as a standard share object) and may couple a database comprising an installation script for installing the application to the application share object. In some embodiments, the installation script may be in the form of a stored procedure. Stored procedures may be similar to functions in the sense that they are both evaluated as expressions. Unlike functions however, stored procedures are used via CALL statements and do not appear in other statement types the way functions do (e.g., in a SELECT or WHERE part of a query). A primary feature of stored procedures is their ability to execute other queries and access their results. As with functions, a stored procedure may be created once and then can be executed many times. Indeed, a stored procedure implemented with, e.g., Javascript can be thought of as a Javascript UDF augmented with the ability to issue other queries during execution of the Javascript body. When a consumer imports the database that is coupled to the application share object locally, it will trigger execution of the installation script, which will build out all of the objects and procedures required for the application to run as discussed in further detail herein.

Some database operations performed by the compute service manager 108 (and in some cases by an instance of a process or session and/or a native application) can include an operation to share and manage access privileges to one or more database objects. For example, the database object can be associated with a first set of access privileges for a first entity to perform. The first set of access privileges define what actions or operations the first entity can perform. A second entity may have no access privileges and may not even know the storage location or existence of the database object. In such cases, the first entity can share at least a portion or subset of the first set of access privileges with the second entity through a reference and, in some cases, using the native application. To do so, the first entity can generate a reference to the database object and can specify one or more scope definitions that specify persistence of the database object (e.g., whether the reference expires, is temporary, is session based, and/or is persistent until deleted). The reference can be stored in a table that associates the database object with the scope definition and various access privileges. The first entity (or native application) can call a function that passes the reference to the second entity as a parameter or argument and the second entity is then provided the access privileges to perform one or more database operations on the associated database object.

The native applications may create a set of database roles as part of the installation of the application to assist with the sharing procedure. More specifically, the native applications may create a primary database role, which may represent the application itself and may control execution of the installation script and control the use or execution of any objects or procedures corresponding to the application functionality generated by the installation script. Stated differently, the primary database role may have control over the application, analogous to a top level role in an account. The primary database role may enable the installation script to be executed in the context of the consumer account but using a model that is similar to (but not the same as) the provider account rights.

The native applications may also create an exporter database role to which the installation script may grant permissions to certain objects and/or procedures (corresponding to the application functionality) that the installation script has created during installation of the application. These objects can be granted permission through the disclosed references. The native applications may also create an importer database role. When objects/permissions of the consumer account are granted to the application, the imported database role may automatically acquire these objects/permissions, such as by calling the reference function. The native applications may automatically grant the importer database role to the primary database role such that the primary database role can assume all permissions granted to the application (via the importer database role). The native applications may also automatically grant the exporter database role to the admin role, which is an account level role of the consumer account. As a result, the certain objects and/or procedures granted to the exporter database role by the installation script may be visible to/accessible by the consumer account (e.g., accessible by the admin role).

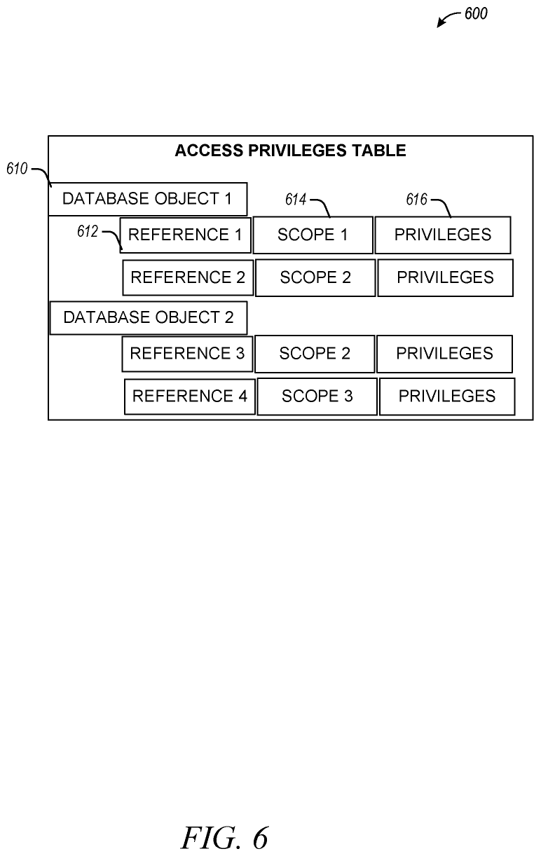

The compute service manager 108 is also coupled to one or more metadata databases 112 that store metadata about various functions and aspects associated with the network-based data platform 102 and its users. The metadata database 112 can store the table that provides the mapping between database objects and references to the objects, identity of objects, scope definitions of the objects, and/or access privileges of the objects, such as the access privileges table 600, shown in FIG. 6. For example, a metadata database 112 may include a summary of data stored in remote data storage systems as well as data available from a local cache. Additionally, a metadata database 112 may include information regarding how data is organized in remote data storage systems (e.g., the cloud storage platform 104) and the local caches. Information stored by a metadata database 112 allows systems and services to determine whether a piece of data needs to be accessed without loading or accessing the actual data from a storage device. In some cases, metadata database 112 is configured to store account object metadata. In some cases, the metadata database 112 can store an access history associated with one or more references to database objects to enable an owner of the database objects to audit access to the database objects.

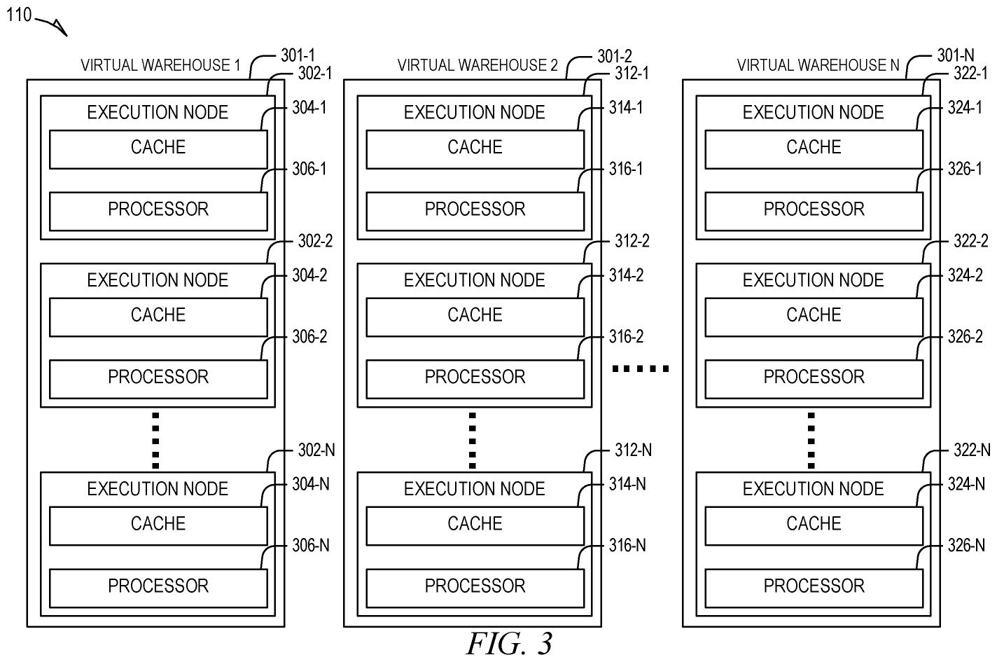

The compute service manager 108 is further coupled to the execution platform 110, which provides multiple computing resources that execute various data storage and data retrieval tasks. As illustrated in FIG. 3, the execution platform 110 comprises a plurality of compute nodes. The execution platform 110 is coupled to storage platform 104 and cloud storage platforms 122. The storage platform 104 comprises multiple data storage devices 120-1 to 120-N. In some examples, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3™ storage systems, or any other data-storage technology. Additionally, the cloud storage platform 104 may include distributed file systems (such as Hadoop Distributed File Systems (HDFS)), object storage systems, and the like.

In some examples, at least one storage device cache 126 (e.g., an internal cache) may reside on one or more of the data storage devices 120-1 to 120-N, and at least one external stage 124 may reside on one or more of the cloud storage platforms 122. In some examples, a single storage device cache 126 can be associated with all of the data storage devices 120-1 to 120-N so that the single storage device cache 126 is shared by and can store data associated with any one of the data storage devices 120-1 to 120-N. In some examples, each data storage device data of storage devices 120-1 to 120-N can include or implement a separate storage device cache 126. A cache manager 128 handles the transfer of data from the data storage devices 120-1 to 120-N to the storage device cache 126. The cache manager 128 handles the eviction of data from the storage device cache 126 to the respective associated data storage devices 120-1 to 120-N. The storage platform 104 can include one or more hard drives and/or can represent a plurality of hard drives distributed on a plurality of servers in a cloud computing environment.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another. In alternate examples, these communication links are implemented using any type of communication medium and any communication protocol.

The compute service manager 108, metadata database(s) 112, execution platform 110, and storage platform 104 are shown in FIG. 1 as individual discrete components. However, each of the compute service manager 108, metadata database(s) 112, execution platform 110, and storage platform 104 may be implemented as a distributed system (e.g., distributed across multiple systems/platforms at multiple geographic locations). Additionally, each of the compute service manager 108, metadata database(s) 112, execution platform 110, and storage platform 104 can be scaled up or down (independently of one another) depending on changes to the requests received and the changing needs of the network-based data platform 102. Thus, in the described embodiments, the network-based data platform 102 is dynamic and supports regular changes to meet the current data processing needs.

During a typical operation, the network-based data platform 102 processes multiple jobs (e.g., operators of sub-plans) determined by the compute service manager 108. These jobs (e.g., caller processes) are scheduled and managed by the compute service manager 108 to determine when and how to execute the job. For example, the compute service manager 108 may divide the job into multiple discrete tasks (e.g., caller processes) and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task (e.g., in a storage device cache 126, such as an HDD cache or random access memory (RAM)) and, therefore, be a good candidate for processing the task. Metadata stored in a metadata database 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the cloud storage platform 104. It is desirable to retrieve as much data as possible from caches within the execution platform 110 because the retrieval speed is typically much faster than retrieving data from the cloud storage platform 104.

According to various examples, the execution platform 110 executes a query according to a query plan determined by the compute service manager 108. As part of executing the query, the execution platform performs a table scan in which one or more portions of a database table are scanned to identify data that matches the query. More specifically, the database table can be organized into a set of files where each file comprises a set of blocks (or records) and each block (or record) stores at least a portion of a column (or row) of the database. Each execution node provides multiple threads of execution, and in performing a table scan, multiple threads perform a parallel scan of the set of blocks (or records) of a file, which may be selected from a scan set corresponding to a subset of the set of files into which the database is organized.

The cloud computing platform 101 of the computing environment 100 separates the execution platform 110 from the storage platform 104. In this arrangement, the processing resources and cache resources in the execution platform 110 operate independently of the data storage devices 120-1 to 120-N in the cloud storage platform 104. Thus, the computing resources and cache resources are not restricted to specific data storage devices 120-1 to 120-N. Instead, all computing resources and all cache resources may retrieve data from, and store data to, any of the data storage resources in the cloud storage platform 104.

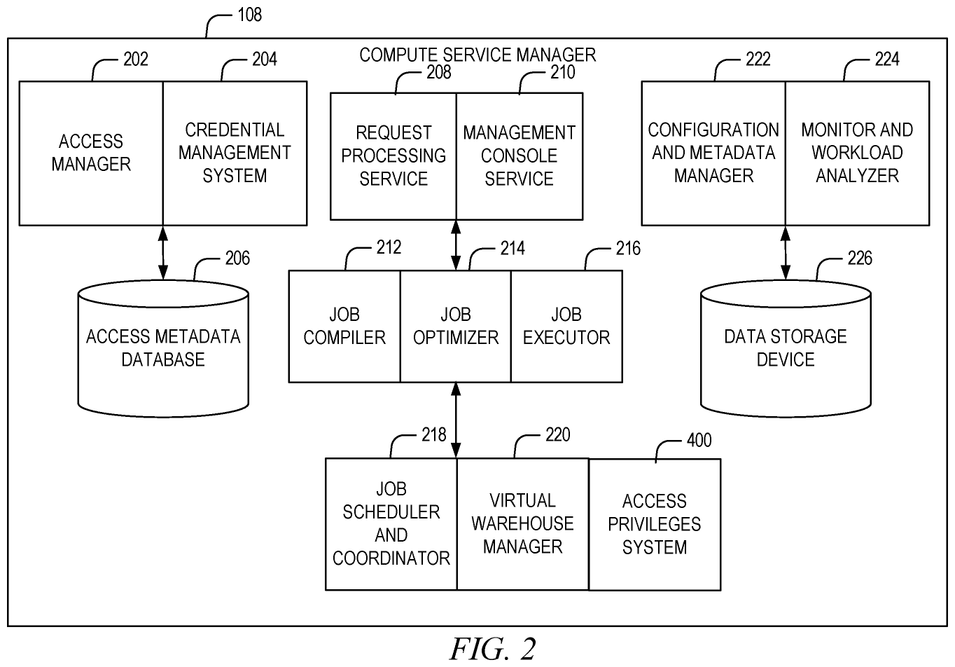

FIG. 2 is a block diagram illustrating components of the compute service manager 108, in accordance with some examples. As shown in FIG. 2, the compute service manager 108 includes an access manager 202 and a credential management system 204 coupled to an access metadata database 206, which is an example of the metadata database(s) 112. Access manager 202 handles authentication and authorization tasks for the systems described herein. The credential management system 204 facilitates the use of remotely stored credentials to access external resources such as data resources in a remote storage device. In some cases, any operations performed by the access manager 202 and/or credential management system 204 can be performed by the access privileges system 400 and vice versa. As used herein, the remote storage devices may also be referred to as “persistent storage devices,” “non-volatile storage devices,” “cloud storage devices,” or “shared storage devices.” For example, the credential management system 204 may create and maintain remote credential store definitions and credential objects (e.g., in the access metadata database 206).

A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the access metadata database 206 (e.g., a credential object and a credential store definition) to retrieve security credentials used to access the external resource from a remote credential store.

In some cases, the first set of access privileges that are associated with the first entity can include one or more credentials of the first entity that are stored by the credential management system 204. The first entity can share such one or more credentials with the second entity according to a scope definition associated with a reference to a database object and without revealing the contents of the credentials of the first entity. Particularly, the reference that includes a random sequence of characters (string) is internally associated with the credentials of the first entity. This reference is provided to the second entity by calling a function and passing the reference as an argument to the second entity, which keeps hidden the credentials of the first entity. The second entity can call a function using the reference. In response to calling the function, the credential management system 204 can locate the credentials of the first entity using the reference and allow the second entity to perform one or more operations associated with the function using the credentials of the first entity and limited by the privileges associated with the reference.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110, in a storage device cache 126, or in a data storage device in storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. Job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and then processed in that prioritized order. In an embodiment, the job scheduler and coordinator 218 determines a priority for internal jobs that are scheduled by the compute service manager 108 with other “outside” jobs such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries by one or more execution nodes of the execution platform 110. In some cases, the compute service manager 108 includes an access privileges system 400, discussed in more detail below, to handle jobs of the job executor 216.

Additionally, the compute service manager 108 includes a configuration and metadata manager 222, which manages the information related to the data stored in the remote data storage devices and the local buffers (e.g., the buffers in execution platform 110). The configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the network-based data platform 102 and may further redistribute tasks based on a user (e.g., “external”) query workload that may also be processed by the execution platform 110. The configuration and metadata manager 222 and the monitor and workload analyzer 224 are coupled to a data storage device 226. The data storage device 226 in FIG. 2 represents any data storage device within the network-based data platform 102. For example, data storage device 226 may represent buffers in execution platform 110, storage devices in storage platform 104, or any other storage device.

FIG. 3 is a block diagram illustrating components of the execution platform 110, which can be implemented by any of the virtual warehouses of the execution platform 110, in accordance with some embodiments of the present disclosure. As shown in FIG. 3, the execution platform 110 includes multiple virtual warehouses, including virtual warehouse 1 (or 301-1), virtual warehouse 2 (or 301-2), and virtual warehouse N (or 301-N). Each virtual warehouse includes multiple execution nodes that each include a data cache and a processor. The virtual warehouses can execute multiple tasks in parallel by using multiple execution nodes. As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in the cloud storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing data from any of the data storage devices 120-1 to 120-N and their associated storage device cache 126 (e.g., via a respective lock file) shown in FIG. 1. Thus, the virtual warehouses are not necessarily assigned to a specific data storage device 120-1 to 120-N and, instead, can access data from any of the data storage devices 120-1 to 120-N within the cloud storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some examples, the execution nodes shown in FIG. 3 are stateless with respect to the data being cached by the execution nodes. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternative embodiments may include execution nodes containing any number of processors and any number of caches. Additionally, the caches may vary in size among the different execution nodes. The caches shown in FIG. 3 store, in the local execution node, data that was retrieved from one or more data storage devices in the cloud storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud storage platform 104. The techniques described with respect to the cache manager 128 of the storage platform 104 (e.g., a HDD) can be similarly applied to the cache 304-N, 314-N, and 324-N of the execution nodes 302-N, 312-N, and 322-N.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, virtual warehouses 1, . . . , N may be implemented using multiple computing systems at multiple geographic locations. For example, virtual warehouse 1 can be implemented by a computing system at a first geographic location, while virtual warehouses 2 and N are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location, and execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault-tolerant. For example, if one virtual warehouse fails, that virtual warehouse is quickly replaced with a different virtual warehouse at a different geographic location. A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some examples, the virtual warehouses may operate on the same data in the cloud storage platform 104, but each virtual warehouse has its execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

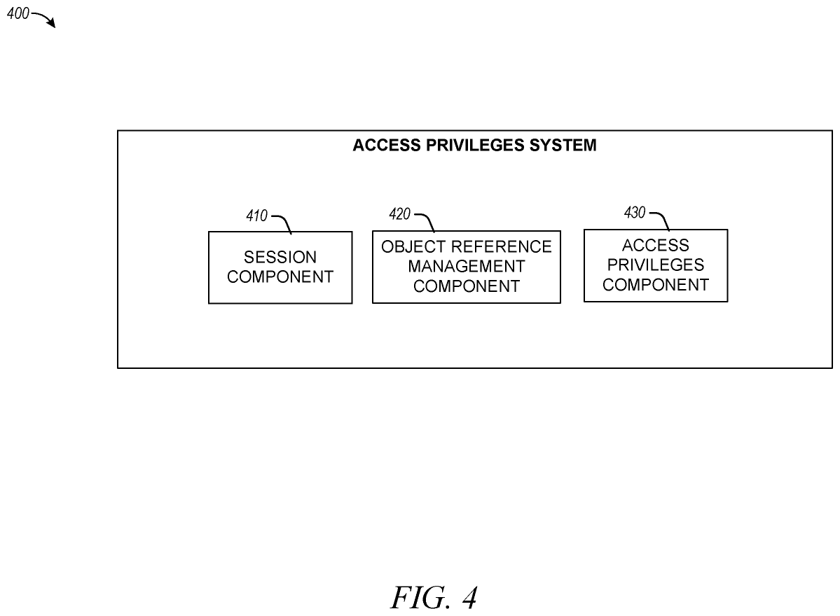

FIG. 4 is a block diagram illustrating an example of the access privileges system 400, which can be implemented by any components previously mentioned including compute service manager 108 and/or any of the virtual warehouses of the execution platform 110, such as the access manager 202 or credential management system 204, in accordance with some examples. The access privileges system 400 can include a session component 410, an object reference management component 420, and an access privileges component 430. The access privileges system 400 allows the first entity (e.g., through a native application, procedure, nested procedure, instance, and so forth) to share access to one or more database objects to which the first entity currently has access with the second entity according to a scope definition of a reference to the database objects. Specifically, the first entity can provide a set of access privileges to the second entity to allow the second entity to perform one or more database operations on the one or more database objects without revealing the storage location, security settings, or privacy information associated with the one or more database objects. In some cases where the scope definition indicates that the reference is temporary or transient, the set of access privileges provided to the second entity is automatically revoked once the operations are completed and/or once the session is closed or terminated. In some cases where the scope definition indicates that the reference is persistent, reference is deleted revoking the set of access privileges provided to the second entity in response to a call to a function that deletes or deactivates the reference.

A general discussion of access privileges system 400 is first provided followed by detailed explanation of each of the components of the access privileges system 400. In some examples, the access privileges system 400 calls, by a first entity (e.g., a native application of the first entity), a reference generator function using one or more arguments associated with a database object, the first entity is authorized to access according to a first set of access privileges, the one or more arguments including a scope definition that defines persistence of a reference. The access privileges system 400 obtains, from the reference generator function, a reference to the database object, the reference persisting according to the scope definition. The access privileges system 400 passes the reference to a second entity to enable the second entity to perform one or more database operations on the database object according to a second set of access privileges derived from the first set of access privileges. In some examples, the one or more arguments include the second set of access privileges as a subset of the first set of access privileges, the second set of access privileges including at least one or more fewer access privileges than the first set of access privileges.

In some examples, the database object includes a table, an external table, a stream, a view, a materialized view, a materialized table, a warehouse, an API integration, a notification integration, or a function. In some examples, the first entity includes a producer or caller process and the second entity includes a consumer process. In some examples, the database object is accessed by the second entity as a role of the first entity.

In some examples, the access privileges system 400 executes an application or instance by the first entity on a database server. The access privileges system 400 calls the reference generator function as part of the application or instance. The one or more arguments can include an identifier of the database object including a domain of the database object. In some examples, the operations can include passing the reference to the second entity as part of the application or instance and calling, by the application or instance, a remove reference function in association with the database object to delete the reference.

In some examples, the access privileges system 400 stores, in association with the application or instance, a table that maps a unique sequence of characters of the reference to the database object and the second set of access privileges. In some examples, the scope definition defines the reference as a session reference. In such cases, the access privileges system 400 temporarily authorizes the second entity to access the object using the reference during an established session between the first and second entities. In some examples, the scope definition defines the reference as a root query reference. In such cases, the access privileges system 400 temporarily authorizes the second entity to access the object using the reference throughout a sequence of operations defined by top-level query to a procedure which calls one or more additional procedures.

In some examples, the scope definition defines the reference as a persistent reference, which has an unlimited life span until removed by the first entity. In such cases, the access privileges system 400 determines that the second set of access privileges are undefined by the one or more arguments. In response to determining that the second set of access privileges are undefined by the one or more arguments, the access privileges system 400 sets default privileges as the second set of access privileges including at least one or more fewer access privileges than the first set of access privileges. In some examples, the access privileges system 400 presents, to the first entity, access history associated with the database object, the access history representing various operations performed on the database object using the reference. In some cases, the various operations include at least one of INSERT, UPDATE, DELETE, and/or COPY operations.

In some examples, the access history represents a history of instance or application queries associated with the database object accessed using the reference. In some examples, the access history includes at least one of a query identifier, a query start time, a username, one or more database objects accessed, and/or one or more database objects modified.

Referring specifically to the components of the access privileges system 400, the session component 410 is configured to allow a first entity to establish a secure or unsecure communication session with a second entity. The first entity can be a first process running on one or more processing devices that are the same or different as a second process corresponding to the second entity. The first and second entities can be associated with a same company or user or different companies or users. In some examples, the first entity is associated with first access credentials used to log into the computing environment 100 and the second entity is associated with second access credentials used to log into the computing environment 100. The second entity may generate one or more SQL statements using an API of the first entity to communicate information with the first entity and to access information associated with a database of the first entity. Once a session is established between the first and second entities, such as based on the first and second entities requesting to communicate with each other using the computing environment 100, a session identifier (session ID) is stored by the session component 410 that identifies the first and second entities.

One or more data structures that represent APIs of each of the first and second entities can be stored in the computing environment 100 in association with the session ID. The first and second entities can communicate with each other using the session ID that has been established by the session component 410.

The first entity can have access to one or more database objects that are stored by the computing environment 100. The one or more objects can include tables, functions, data entries, or any other data structure. The computing environment 100 can store a first set of privileges that the first entity has for processing or operating on one or more objects. The first set of privileges can also indicate privacy and security information that is needed to operate on the one or more objects. The first entity may identify the one or more objects to make available to the second entity for processing. The first entity can communicate the identity of the one or more objects, such as using object identifiers or address locations, to the object reference management component 420.

In some examples, the session component 410 can be accessed or activated in response to the first entity (or process or procedure of the first entity) calling a reference generator function. The reference generator function can allow the first entity to identify which one or more database objects are enabled to have a reference associated with them. The first entity can define specific portions of the one or more database objects that are shareable via a reference and such portions can then be provided a unique identifier. The first entity can then call the reference generator function including one or more arguments to define a string or unique sequence of characters defining a reference that are used to associate the owner rights or credentials or subset of credentials of the first entity with a second entity or other process or procedure of the first entity. The object reference management component 420 can receive the identifier of a specified database object along with the one or more arguments and can generate the reference according to the scope definition of the one or more arguments. The reference generator function can take in as its arguments a domain of the database object, a name of the database object, the scope (e.g., whether the reference is transient or persistent), and the access privileges. The values of these arguments can be stored in the corresponding entry of the table 600 for the database object field.

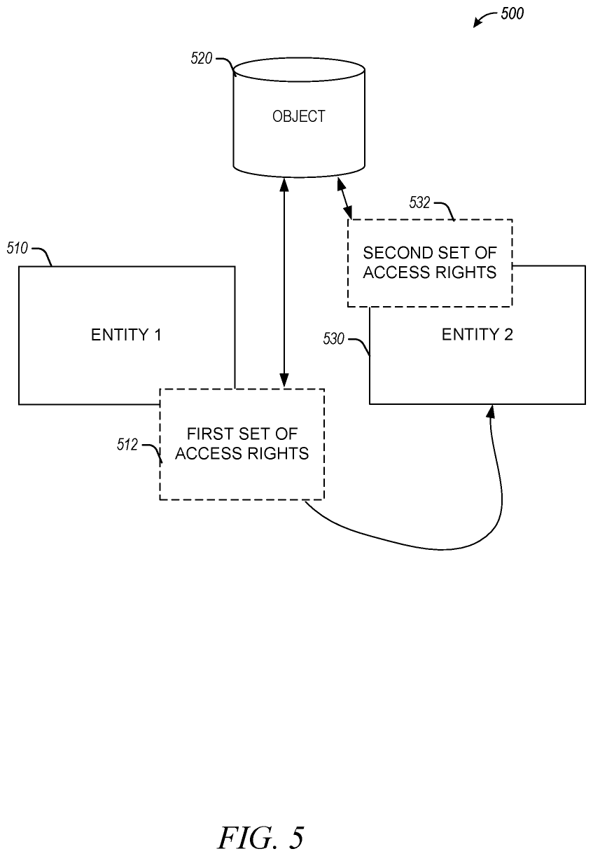

For example, as shown in the system 500 of FIG. 5, the first entity 510 can establish a communication session with the second entity 530, such as by calling a function of the second entity 530. The first entity 510 can be associated with a first set of access rights 512 that can be used to access one or more objects 520 stored in the database of the computing environment 100. The first entity 510 can select a default set or a specified subset of the access rights 512 to share with the second entity 530. The object reference management component 420 can generate an access privileges table, such as the table 600 shown in FIG. 6. In some cases, the object reference management component 420 determines that the table 600 is already generated and adds one or more entries to the table 600 in response to receiving the identification of the one or more objects from the first entity 510 through the reference generator function call.

As an example, the object reference management component 420 stores in a database object identifier field 610, the database object identifier received from the session component 410 that identifies the database object or portion thereof to share access with the second entity 530. In association with the database object identifier field 610, the object reference management component 420 stores the reference in the reference field 612 (e.g., the random sequence of textual characters that have been generated) along with the storage location or identity of the one or more objects, the scope definition in the scope field 614, and the specified subset of the access rights 512 (e.g., the second set of access rights 532) in the privileges field 616.

In some examples, the specified subset of the access rights 512 (e.g., the second set of access rights 532) in the privileges field 616 correspond to a default set of access rights that are the exact same or a subset of less than all of the access rights or privileges of the first entity 530. This can be the case if the first entity calls the reference generator function without specifying the privileges as an argument passed to the reference generator function. For example, the first entity 530 can have read and write access rights to the one or more objects 520 and the specified subset of the access rights 512 include read only rights. In some cases, the object reference management component 420 determines that one or more access rights of the first entity 510 have changed (e.g., been reduced to read only rights). In such cases, the object reference management component 420 automatically updates the access rights stored in the privileges field 616 so that the second entity 530 is never provided more privileges or access rights than the first entity 510 relative to the one or more objects 520.

If the database identifier is already included in one of the database object identifier fields 610, indicating that other references have previously been stored in the table 600 for the same database object, the object reference management component 420 appends another entry to the table 600 with the reference field 612 including the generated reference along with the storage location or identity of the one or more object identifier fields 610 and the privileges field 616. In some cases, the object reference management component 420 also stores the condition for deleting or revoking the second set of access rights 532 provided to the second entity 530 in the table 600. This condition can be derived based on the scope field 614. In some cases, the condition corresponds to a session. In such cases, the corresponding reference is deleted when a session between the first entity and the second entity is closed or terminated. In some cases, the condition corresponds to a root query that calls one or more additional procedures or subqueries. In such cases, the corresponding reference is deleted when the root query completes execution following execution of the one or more additional procedures or subqueries. In some cases, the condition is permanent or persistent, in which case the reference is deleted or deactivated when a reference removal function is called by the first entity (or process associated with the first entity).

Referring back to FIG. 4, the object reference management component 420 communicates the reference to the second entity 530. The second entity 530 can call a variety of database functions and execute various SQL statements. In some cases, when the second entity needs to use the one or more objects 520 that are associated with the first entity 510, the second entity uses the reference received from the object reference management component 420. Specifically, the second entity can call a function that takes the reference as input parameters, fields, or arguments. In response to calling the function, the reference is transmitted to the first entity 510 along with data and other parameters and operations of the function.

In some examples, the second entity 530 can call a function to operate on the one or more database objects associated with a certain reference. When the one or more database objects are accessed, the access privileges system 400 can search the table 600 to find the privileges field 616 associated with the reference. The access privileges component 430 can then receive an access or operation from the second entity 530 and can determine if that access or operation falls within the list of allowable privileges associated with the reference. The access privileges component 430 can then allow or disallow the second entity 530 to perform the one or more database operations based on whether the access or operation falls within the list of allowable privileges associated with the reference.

In some examples, the first entity (or native application or process of the first entity) can initially create a procedure that constructs an identifier or link to a database object, such as using a reference definition function. This function creates an identifier of the database object and lists the privileges of the first entity and the domain of the database object. The first entity can then call a reference generator function as another SQL statement to generate a reference using the identifier or link to the database object according to a specified scope (e.g., defining whether the reference is transient or persistent) and one or more access privileges. The reference generator function can verify that the domain of the reference matches the domain specified in a reference definition table or the domain of the database object being identified. The reference generator function can also verify that the privileges of the reference specified in one or more arguments of the reference generator function match or are a superset of the privileges specified in the reference definition. In some cases, if the reference generator function determines that a scope definition corresponds to persisting the reference, the privileges that are persisted are restricted to the privileges specified in the reference definition.

A function of the second entity can be called by the first entity (or native application or process of the first entity) using the reference returned by the reference generator function. In some cases, the function can specify the identity of the database object along with the reference. The second entity can perform one or more database operations on the database object using the reference. Such operations can be stored and tracked in a history of the access table. The first entity can then call a remove reference function to delete or deactivate the reference to prevent further access sharing to the database object. The remove reference function can be called by the first entity after calling one or more additional functions and/or procedures that use the same reference for the same database object.

In some examples, the first entity can remove a reference definition by creating a new version of the instance of native application. In such cases, any references stored in the table 600 that correspond to a database object identifier that is included in the new version are deactivated, invalidated, or deleted. To do so, the first entity can call a function that lists all reference definitions and determines whether any of the reference definitions correspond to a database object that is subject to being changed or updated in the new version. Any such database object is then matched to the corresponding reference stored in the table 600 and that reference is deactivated.

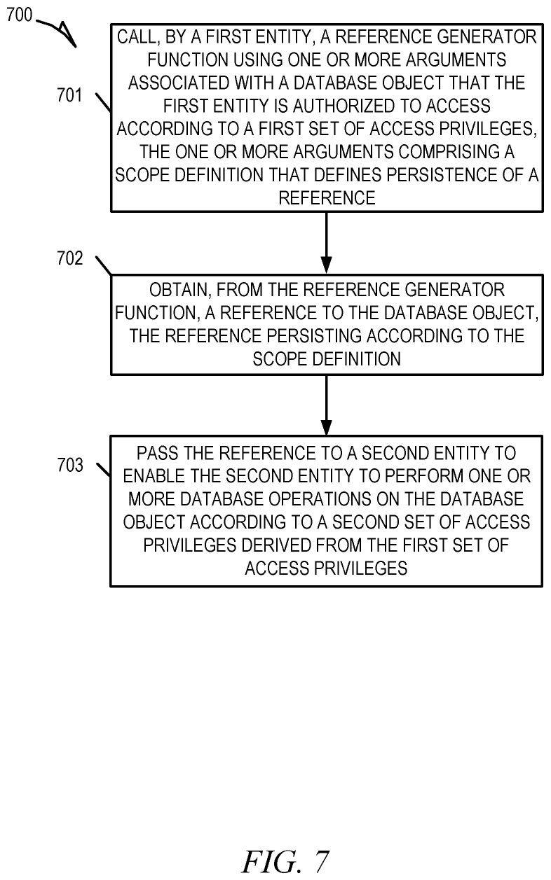

FIG. 7 is a flow diagram illustrating operations and/or methods 700 of the access privileges system 400, in accordance with some embodiments of the present disclosure. The operations and/or methods 700 may be embodied in computer-readable instructions for execution by one or more hardware components (e.g., one or more processors) such that the operations of the operations and methods 700 may be performed by components of data platform 102 such as the execution platform 110. Accordingly, the operations and/or methods 700 is described below, by way of example with reference thereto. However, it shall be appreciated that operations and/or methods 700 may be deployed on various other hardware configurations and is not intended to be limited to deployment within the data platform 102. Depending on the embodiment, an operation of the operations and/or methods 700 may be repeated in different ways or involve intervening operations not shown. Though the operations of the operations and/or methods 700 may be depicted and described in a certain order, the order in which the operations are performed may vary among embodiments, including performing certain operations in parallel or performing sets of operations in separate processes.

At operation 701, the access privileges system 400 calls, by a first entity, a reference generator function using one or more arguments associated with a database object that the first entity is authorized to access according to a first set of access privileges, the one or more arguments comprising a scope definition that defines persistence of a reference, as discussed above.

At operation 702, the access privileges system 400 obtains, from the reference generator function, a reference to the database object, the reference persisting according to the scope definition, as discussed above.

At operation 703, the access privileges system 400 passes the reference to a second entity to enable the second entity to perform one or more database operations on the database object according to a second set of access privileges derived from the first set of access privileges, as discussed above.

Described implementations of the subject matter can include one or more features, alone or in combination as illustrated below by way of example.

Example 1. A system comprising: at least one hardware processor; and at least one memory storing instructions that cause the at least one hardware processor to execute operations comprising: calling, by a first entity, a reference generator function using one or more arguments associated with a database object that the first entity is authorized to access according to a first set of access privileges, the one or more arguments comprising a scope definition that defines persistence of a reference; obtaining, from the reference generator function, a reference to the database object, the reference persisting according to the scope definition; and passing the reference to a second entity to enable the second entity to perform one or more database operations on the database object according to a second set of access privileges derived from the first set of access privileges.

Example 2. The system of Example 1, wherein the database object comprises a table, external table, a stream, a view, a materialized view, a warehouse, an application programming interface integration, a notification integration, or a function.

Example 3. The system of any one of Examples 1-2, wherein the first entity comprises a producer or caller process and the second entity comprises a consumer process.

Example 4. The system of any one of Examples 1-3, wherein the database object is accessed by the second entity as a role of the first entity.

Example 5. The system of any one of Examples 1-4, wherein the one or more arguments comprise the second set of access privileges as a subset of the first set of access privileges, the second set of access privileges including at least one or more fewer access privileges than the first set of access privileges.

Example 6. The system of any one of Examples 1-5, wherein the operations further comprise: executing an application or instance by the first entity on a database server; and calling the reference generator function as part of the application or instance, wherein the one or more arguments comprise an identifier of the database object including a domain of the database object.

Example 7. The system of Example 6, wherein the operations further comprise: passing the reference to the second entity as part of the application or instance; and calling, by the application or instance, a remove reference function in association with the database object to delete the reference.

Example 8. The system of Example 7, wherein the operations further comprise: storing, in association with the application or instance, a table that maps a unique sequence of characters of the reference to the database object and the second set of access privileges.

Example 9. The system of any one of Examples 1-8, wherein the scope definition defines the reference as a session reference, and wherein the operations further comprise temporarily authorizing the second entity to access the object using the reference during an established session between the first and second entities.

Example 10. The system of any one of Examples 1-9, wherein the scope definition defines the reference as a root query reference, and wherein the operations further comprise temporarily authorizing the second entity to access the object using the reference throughout a sequence of operations defined by a top-level query to a procedure which calls one or more additional procedures.

Example 11. The system of any one of Examples 1-10, wherein the scope definition defines the reference as a persistent reference with an unlimited life span until removed by the first entity.

Example 12. The system of any one of Examples 1-11, wherein the operations further comprise: determining that the second set of access privileges are undefined by the one or more arguments; and in response to determining that the second set of access privileges are undefined by the one or more arguments, setting default privileges as the second set of access privileges including at least one or more fewer access privileges than the first set of access privileges.

Example 13. The system of any one of Examples 1-12, wherein the operations further comprise: presenting, to the first entity, access history associated with the database object, the access history representing operations performed on the database object using the reference.

Example 14. The system of Example 13, wherein the operations comprise at least one of INSERT, UPDATE, DELETE, and COPY operations.

Example 15. The system of any one of Examples 13-14, wherein the access history represents a history of instance or application queries associated with the database object accessed using the reference.

Example 16. The system of any one of Examples 13-15, wherein the access history comprises at least one of a query identifier, a query start time, a username, one or more database objects accessed, or one or more database objects modified.

Described implementations of the subject matter can include one or more features, alone or in combination as illustrated below by way of example.

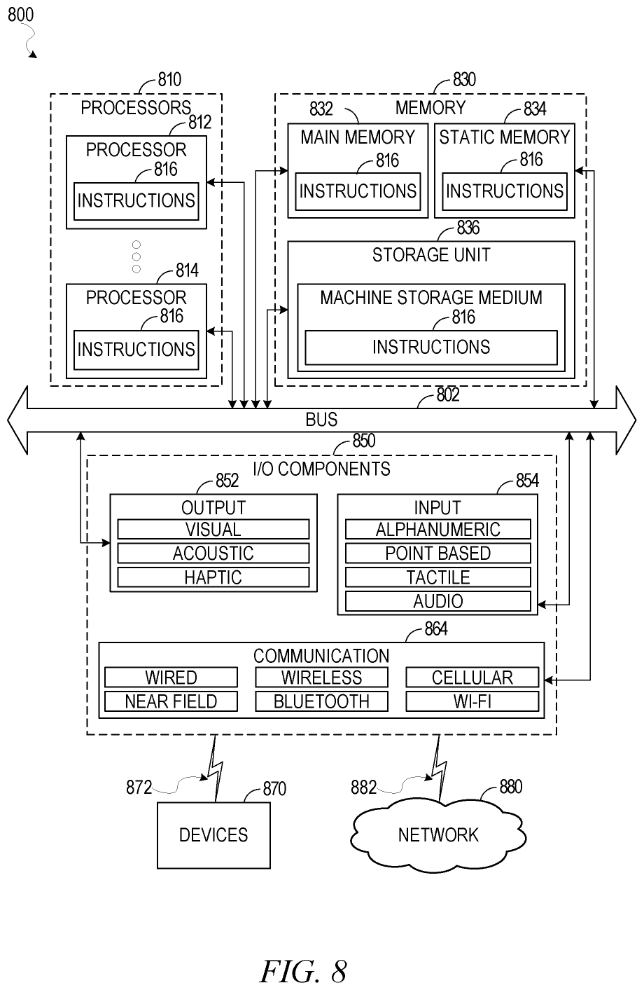

FIG. 8 illustrates a diagrammatic representation of a machine 800 in the form of a computer system within which a set of instructions may be executed for causing the machine 800 to perform any one or more of the methodologies discussed herein, according to an example embodiment. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example, the instructions 816 may cause the machine 800 to execute any one or more operations of the above processes (e.g., operations and/or methods 700). In this way, the instructions 816 transform a general, non-programmed machine into a particular machine 800 (e.g., the compute service manager 108 or one or more execution nodes of the execution platform 110) that is specially configured to carry out any one of the described and illustrated functions in the manner described herein.

In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 includes processors 810, memory 830, and input/output (I/O) components 850 configured to communicate with each other such as via a bus 802. In an example embodiment, the processors 810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 816. The term “processor” is intended to include multi-core processors 810 that may comprise two or more independent processors (sometimes referred to as “cores”) that may execute instructions 816 contemporaneously. Although FIG. 8 shows multiple processors 810, the machine 800 may include a single processor with a single core, a single processor with multiple cores (e.g., a multi-core processor), multiple processors with a single core, multiple processors with multiple cores, or any combination thereof.

The memory 830 may include a main memory 832, a static memory 834, and a storage unit 836, all accessible to the processors 810 such as via the bus 802. The main memory 832, the static memory 834, and the storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 include components to receive input, provide output, produce output, transmit information, exchange information, capture measurements, and so on. The specific I/O components 850 that are included in a particular machine 800 will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, and other communication components to provide communication via other modalities. The devices 870 may be another machine or any of a wide variety of peripheral devices (e.g., a peripheral device coupled via a universal serial bus (USB)). For example, as noted above, the machine 800 may correspond to any one of the compute service manager 108, the execution platform 110, and the devices 870 may include any other computing device described herein as being in communication with the data platform 102.

The various memories (e.g., 830, 832, 834, and/or memory of the processor(s) 810 and/or the storage unit 836) may store one or more sets of instructions 816 and data structures (e.g., software) embodying or utilized by any one or more of the methodologies or functions described herein. These instructions 816, when executed by the processor(s) 810, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple transitory or non-transitory storage devices and/or media (e.g., a centralized or distributed database, and/or associated caches and servers) that store executable transitory or non-transitory instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 880 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., hypertext transfer protocol (HTTP)). Similarly, the instructions 816 may be transmitted or received using a transmission medium via the coupling 872 (e.g., a peer-to-peer coupling) to the devices 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 816 for execution by the machine 800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the process or operations and/or methods 700 may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor; and
at least one memory storing instructions that cause the at least one hardware processor to execute operations comprising:
calling, by a first entity, a reference generator function using one or more arguments associated with a database object that the first entity is authorized to access according to a first set of access privileges, the one or more arguments comprising a scope definition that defines persistence of a reference;
obtaining, from the reference generator function, a reference to the database object, the reference persisting according to the scope definition; and
passing the reference to a second entity to enable the second entity to perform one or more database operations on the database object according to a second set of access privileges derived from the first set of access privileges.

2. The system of claim 1, wherein the database object comprises a table, an external table, a stream, a view, a materialized view, a warehouse, an application programming interface integration, a notification integration, or a function.

3. The system of claim 1, wherein the first entity comprises a producer or caller process and the second entity comprises a consumer process.

4. The system of claim 1, wherein the database object is accessed by the second entity as a role of the first entity.

5. The system of claim 1, wherein the one or more arguments comprise the second set of access privileges as a subset of the first set of access privileges, the second set of access privileges including at least one or more fewer access privileges than the first set of access privileges.

6. The system of claim 1, wherein the operations further comprise:
executing an application or instance by the first entity on a database server; and
calling the reference generator function as part of the application or instance, wherein the one or more arguments comprise an identifier of the database object including a domain of the database object.

7. The system of claim 6, wherein the operations further comprise:
passing the reference to the second entity as part of the application or instance; and
calling, by the application or instance, a remove reference function in association with the database object to delete the reference.

8. The system of claim 7, wherein the operations further comprise:
storing, in association with the application or instance, a table that maps a unique sequence of characters of the reference to the database object and the second set of access privileges.

9. The system of claim 1, wherein the scope definition defines the reference as a session reference, and wherein the operations further comprise temporarily authorizing the second entity to access the object using the reference during an established session between the first and second entities.

10. The system of claim 1, wherein the scope definition defines the reference as a root query reference, and wherein the operations further comprise temporarily authorizing the second entity to access the object using the reference throughout a sequence of operations defined by top-level query to a procedure which calls one or more additional procedures.

11. The system of claim 1, wherein the scope definition defines the reference as a persistent reference with an unlimited life span until removed by the first entity.

12. The system of claim 1, wherein the operations further comprise:
determining that the second set of access privileges are undefined by the one or more arguments; and
in response to determining that the second set of access privileges are undefined by the one or more arguments, setting default privileges as the second set of access privileges including at least one or more fewer access privileges than the first set of access privileges.

13. The system of claim 1, wherein the operations further comprise:
presenting, to the first entity, access history associated with the database object, the access history representing operations performed on the database object using the reference.

14. The system of claim 13, wherein the operations comprise at least one of INSERT, UPDATE, DELETE, and COPY operations.

15. The system of claim 13, wherein the access history represents a history of instance or application queries associated with the database object accessed using the reference.

16. The system of claim 13, wherein the access history comprises at least one of a query identifier, a query start time, a username, one or more database objects accessed, or one or more database objects modified.

17. A method comprising:
calling, by a first entity, a reference generator function using one or more arguments associated with a database object that the first entity is authorized to access according to a first set of access privileges, the one or more arguments comprising a scope definition that defines persistence of a reference;
obtaining, from the reference generator function, a reference to the database object, the reference persisting according to the scope definition; and
passing, by at least one hardware processor, the reference to a second entity to enable the second entity to perform one or more database operations on the database object according to a second set of access privileges derived from the first set of access privileges.

18. The method of claim 17, wherein the database object comprises a table, an external table, a stream, a view, a materialized view, a warehouse, an application programming interface integration, a notification integration, or a function.

19. A computer-storage medium comprising instructions that, when executed by a processor of a machine, configure the machine to perform operations comprising:
calling, by a first entity, a reference generator function using one or more argument associated with a database object the first entity is authorized to access according to a first set of access privileges, the one or more arguments comprising a scope definition that defines persistence of a reference;
obtaining, from the reference generator function, a reference to the database object, the reference persisting according to the scope definition; and
passing the reference to a second entity to enable the second entity to perform one or more database operations on the database object according to a second set of access privileges derived from the first set of access privileges.

20. The computer-storage medium of claim 19, wherein the database object comprises a table, an external table, a stream, a view, a materialized view, a warehouse, an application programming interface integration, a notification integration, or a function.
